(19) United States
(12) Patent Application Publication
(10) Pub. No.: US 2026/0221677 A1
(43) Pub. Date: Jul. 30, 2026

(54) CONNECTOR

(71) Applicant: SUMITOMO WIRING SYSTEMS, LTD., Mie (JP)

(72) Inventors: Nagito NARITA, Mie (JP); Yutaka KOBAYASHI, Mie (JP)

(21) Appl. No.: 19/454,581

(22) Filed: Jan. 21, 2026

(30) Foreign Application Priority Data
Jan. 28, 2025 (JP) 2025-012175

(51) Int. Cl. H01R 4/70; H01R 4/34

(52) U.S. Cl. CPC H01R 4/70; H01R 4/34

(57) ABSTRACT

A connector includes: a bus bar having a first connection portion configured to be connected to a partner terminal, and a second connection portion configured to be connected to a wire-attached terminal; an outer housing configured to house the bus bar; a first bolt configured to fasten and fix the first connection portion to the partner terminal; and an inner housing configured to be housed in the outer housing and cover the bus bar. The inner housing is fastened and fixed together with the first connection portion by the first bolt.

### CROSS-REFERENCE TO RELATED APPLICATIONS

This application is based on and claims priority from Japanese Patent Application No. 2025-012175, filed on January 28, 2025, with the Japan Patent Office, the disclosure of which is incorporated herein in its entirety by reference.

### TECHNICAL FIELD

The present disclosure relates to a connector.

### BACKGROUND

For example, a connector disclosed in Japanese Patent Laid-open Publication No. 2023-031719 includes a bus bar ("connection terminal" in Japanese Patent Laid-open Publication No. 2023-031719) and a connector housing that houses the bus bar. The bus bar has a first connection portion for connection to a partner terminal, and a second connection portion for electrical connection to an electric wire. The connector housing has an opening that exposes the first connection portion of the bus bar. The first connection portion of the bus bar is fastened and fixed to the partner terminal by a bolt inserted through the opening of the housing. The bus bar is thus electrically connected to the partner terminal.

### SUMMARY

In the connector described above, when connecting the first connection portion of the bus bar to the partner terminal with a bolt, it is essential that there is a touch prevention countermeasure to prevent a fastening tool or a worker's finger from touching the bus bar.

An object of the present disclosure is to provide a connector that can prevent the touching of a bus bar when the bus bar and a partner terminal are fastened with a bolt.

A connector according to an aspect of the present disclosure includes: a bus bar having a first connection portion configured to be connected to a partner terminal, and a second connection portion configured to be connected to a wire-attached terminal; an outer housing configured to house the bus bar; a bolt configured to fasten and fix the first connection portion to the partner terminal; and an inner housing configured to be housed in the outer housing and cover the bus bar, wherein the inner housing is fastened and fixed together with the first connection portion by the bolt.

According to the connector of the present disclosure, it is possible to prevent the touching of a bus bar when the bus bar and a partner terminal are fastened with a bolt.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view illustrating a connector according to an embodiment.

FIG. 2 is a cross-sectional view taken along line 2-2 in FIG. 1.

FIG. 3 is an enlarged plan view illustrating an enlargement of a portion of FIG. 2

FIG. 4 is a perspective view illustrating an inner housing and a bolt in the embodiment.

FIG. 5 is a perspective view illustrating an aspect of assembly of the connector in the embodiment.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of the Present Disclosure

First, embodiments of the present disclosure will be listed and described.

[1] A connector according to an aspect of the present disclosure includes: a bus bar having a first connection portion configured to be connected to a partner terminal, and a second connection portion configured to be connected to a wire-attached terminal; an outer housing configured to house the bus bar; a bolt configured to fasten and fix the first connection portion to the partner terminal; and an inner housing configured to be housed in the outer housing and cover the bus bar, wherein the inner housing is fastened and fixed together with the first connection portion by the bolt.

According to this configuration, the bus bar is covered by the inner housing when the bus bar and the partner terminal are fastened together with a bolt. As a result, the inner housing can prevent the touching of the bus bar when the bus bar and the partner terminal are fastened together with a bolt.

[2] An aspect is possible in which, in aspect [1], the inner housing includes a bolt holding portion configured to hold a head portion of the bolt in an unfastened state, and the bolt holding portion is attachable to and detachable from the bolt in the unfastened state.

According to this configuration, the bolt can be held by the bolt holding portion of the inner housing before fastening. This makes it possible to handle the inner housing and the bolt held by the bolt holding portion as a single assembly. As a result, it is possible to improve workability when fastening and fixing the bus bar and the inner housing to the partner terminal.

[3] An aspect is possible in which, in aspect [1] or [2], the head portion of the bolt has a first seating surface configured to come into contact with the first connection portion, and a second seating surface having a larger diameter than the first seating surface and configured to come into contact with a fastened portion that is a portion of the inner housing, and the fastened portion is fixed by being sandwiched by the first connection portion and the second seating surface.

According to this configuration, the head portion of the bolt can be brought into direct contact with the bus bar at the first seating surface, and the fastened portion of the inner housing can be fixed by the second seating surface of the head portion of the bolt.

[4] An aspect is possible in which, in any of aspects [1] to [3], the inner housing includes a first cover portion configured to cover the first connection portion, and a second cover portion configured to cover the second connection portion.

According to this configuration, the first connection portion and the second connection portion of the bus bar can be covered by the first cover portion and the second cover portion of the inner housing, respectively. Therefore, the inner housing can more effectively prevent the touching of the bus bar when the bus bar and the partner terminal are fastened together with a bolt.

[5] An aspect is possible in which, in aspect [4], letting the bolt be a first bolt, the connector further comprises a second bolt configured to fasten and fix the second connection portion and the wire-attached terminal to each other, and the second cover portion covers the second connection portion and a head portion of the second bolt.

According to this configuration, the second cover portion of the inner housing can prevent the touching of the second bolt that fixes the bus bar and the wire-attached terminal to each other.

[6] An aspect is possible in which, in aspect [4] or [5], the bus bar is shaped such that the first connection portion is lower than the second connection portion, and the inner housing includes a third cover portion configured to cover a joining portion that connects the first connection portion and the second connection portion of the bus bar.

According to this configuration, the joining portion that connects the first connection portion and the second connection portion of the bus bar can be covered by the third cover portion of the inner housing. Therefore, the inner housing can more effectively prevent the touching of the bus bar when the bus bar and the partner terminal are fastened together with a bolt.

### Details of Embodiments of the Present Disclosure

Specific examples of a connector according to the present disclosure will be described below with reference to the drawings. In the drawings, for ease of description, some parts of the configuration may be exaggerated or simplified. Furthermore, the dimensional ratios of components may differ between drawings. An X axis, a Y axis, and a Z axis that are orthogonal to each other are shown in the drawings. The front-rear direction of the connector extends along the X axis, and in the drawings, a forward direction X1 and a rearward direction X2 are opposite directions along the X axis. The width direction of the connector extends along the Y axis. The height direction of the connector extends along the Z axis, and in the drawings, an upward direction Z1 and a downward direction Z2 are opposite directions in the height direction, which extends along the Z axis. Note that the connector can be placed in any orientation, and is not necessarily used in an orientation in which the upward direction Z1 faces upward.

In this specification, "vertical" and "orthogonal" do not only mean strictly vertical and orthogonal, but also include roughly vertical and orthogonal within the scope of the functions and effects of the present embodiment. The term "tubular" as used in the description of this specification does not only refer to a shape having a peripheral wall that extends continuously around the entire circumference, but also includes a tubular shape formed by combining multiple components, and a C-like shape having a cutout or the like along a portion of the circumference. A "tubular" peripheral shape is a concept including, but not limited to, a circle, an ellipse, and a polygon having sharp or rounded corners. Also, the term "tubular" refers to a shape having a through hole in a plan view, and includes shapes in which the outer peripheral shape and the inner peripheral shape of the through hole are the same as each other, and shapes in which the outer peripheral shape and the inner peripheral shape of the through hole are different from each other. The term "tubular" includes shapes having a predetermined length along the axial direction of the central axis passing through the center of the through hole, and there is no limitation on the magnitude of this length. Furthermore, terms such as "first," "second," and "third" are used in this specification simply to distinguish between objects and are not used to rank objects. The present invention is not limited to these examples, but rather is defined by the scope of the claims, and is intended to include all modifications within the meaning and scope equivalent to the claims.

### Configuration of connector 10

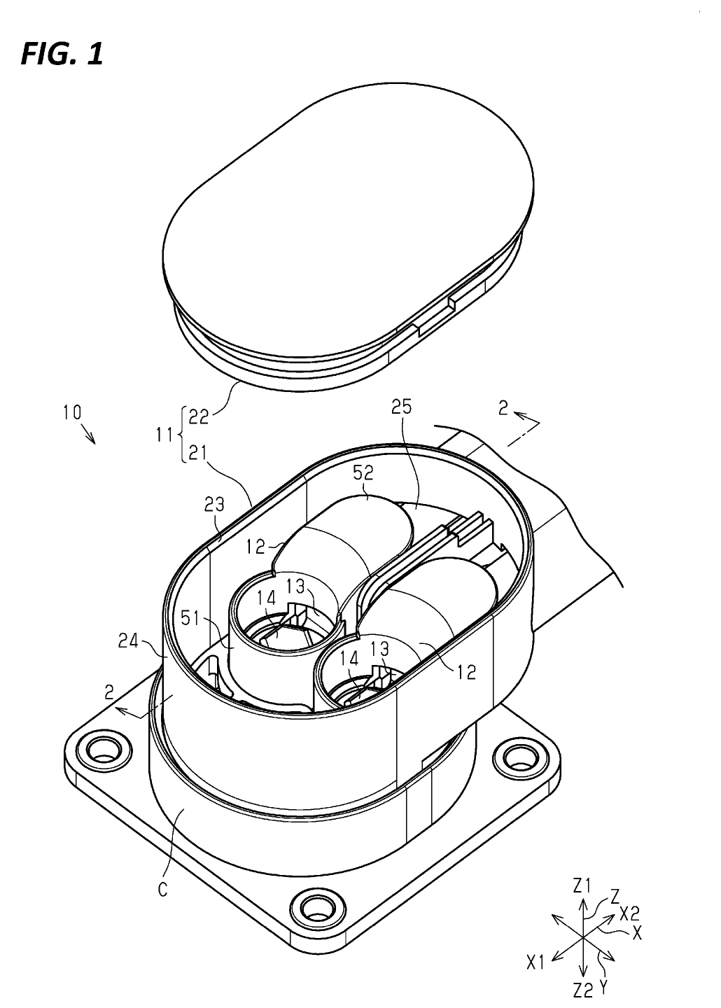

A connector 10 of the present embodiment shown in FIG. 1 is used in, for example, an electric vehicle or a hybrid vehicle. The connector 10 is for connection to a partner connector C attached to an in-vehicle device (not shown).

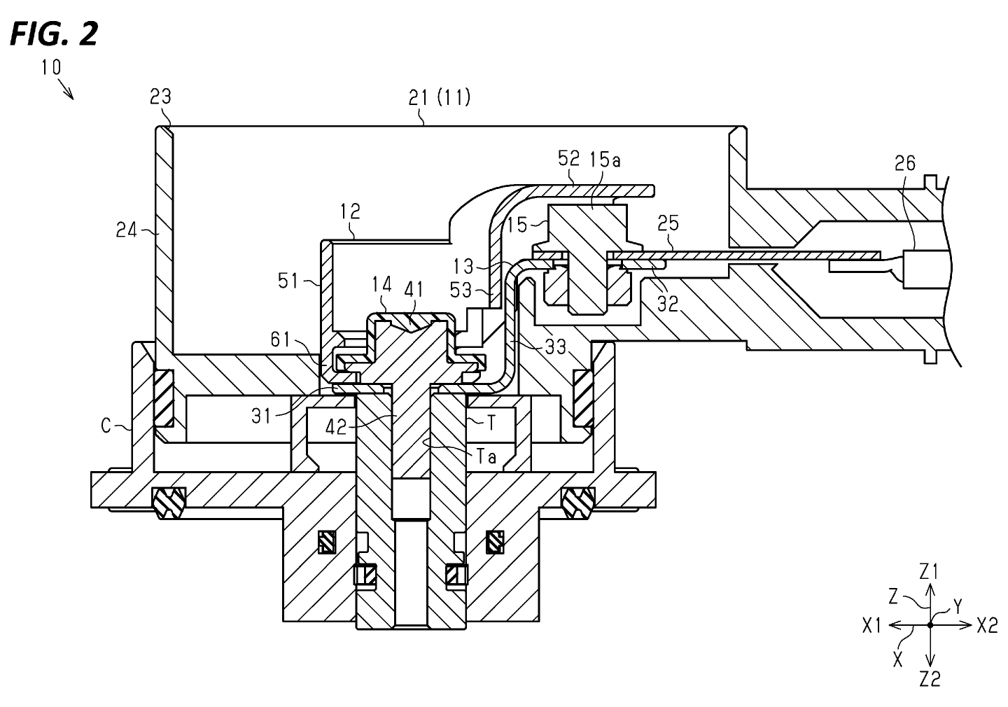

As shown in FIGS. 1 and 2, the connector 10 includes an outer housing 11, inner housings 12, bus bars 13, first bolts 14, and second bolts 15.

### Configuration of outer housing 11

As shown in FIG. 1, the inner housings 12 and the bus bars 13 are housed in the outer housing 11. The outer housing 11 includes a housing body 21 that is fitted to the partner connector C, and a lid 22 that is attached to the housing body 21. Note that for ease of description, the lid 22 is not shown in FIG. 2. The housing body 21 includes a tubular portion 24 having an upper opening portion 23 that is open in the upward direction Zi. The inner housings 12 and the bus bars 13 are housed inside the tubular portion 24. The lid 22 is attached to the housing body 21 so as to close the upper opening portion 23.

As shown in FIG. 2, the connector 10 includes wire-attached terminals 25 connected to the bus bars 13. One end of an electric wire 26 is connected to each of the wire-attached terminals 25 by crimping or the like. The wire-attached terminals 25 are electrically connected to the bus bars 13, which are disposed inside the housing body 21, by being fastened thereto with the second bolts 15, for example. The electric wires 26 are drawn out to the outside of the housing body 21. The wire-attached terminals 25 are made of, for example, aluminum or an aluminum alloy. The cores of the electric wires 26 are made of, for example, aluminum or an aluminum alloy. The second bolts 15 are entirely made of a metal, for example.

### Configuration of bus bar 13

The bus bars 13 have a strip-like shape and are formed by pressing a metal plate, for example. The bus bars 13 are made of, for example, copper or a copper alloy. The bus bars 13 are bent in the thickness direction, for example. Note that in the present embodiment, two bus bars 13, two partner terminals T, and two wire-attached terminals 25 are provided.

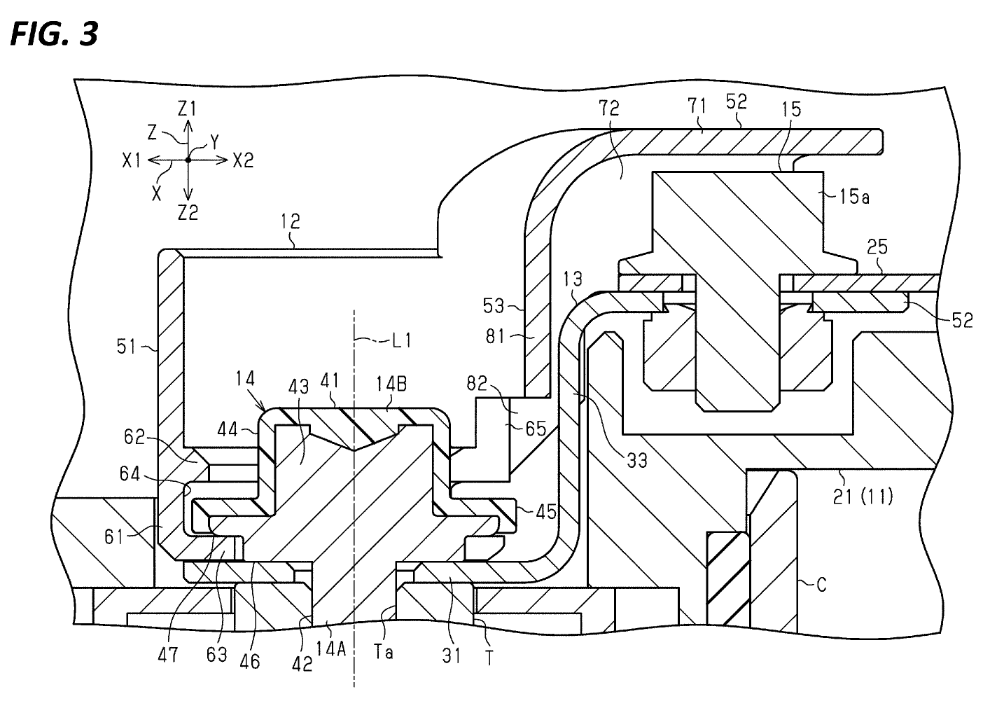

As shown in FIG. 3, each of the bus bars 13 has a first connection portion 31 for connection to the corresponding partner terminal T of the partner connector C, a second connection portion 32 for connection to the corresponding wire-attached terminal 25, and a joining portion 33 that connects the first connection portion 31 and the second connection portion 32 to each other.

The first connection portion 31 is provided at the front end portion of the bus bar 13, for example. The second connection portion 32 is provided at the rear end portion of the bus bar 13, for example. The first connection portion 31 and the second connection portion 32 each extend perpendicular to the height direction (Z axis direction) of the connector 10, for example. The first connection portion 31 is located on the downward direction Z2 side of the second connection portion 32. The joining portion 33 extends along the Z axis direction. In the bus bar 13, the portion where first connection portion 31 and the joining portion 33 are connected is bent at a substantially right angle. Also, the portion of the bus bar 13 where the second connection portion 32 and the joining portion 33 are connected is bent at a substantially right angle. In other words, the bus bar 13 has a shape in which the intermediate portion in the length direction thereof is bent in a crank shape.

In the bus bar 13, the first connection portion 31 is fastened and fixed to the partner terminal T by the first bolt 14. The second connection portion 32 is fastened and fixed to the wire-attached terminal 25 by the second bolt 15. In other words, the electric wire 26 and the partner terminal T are electrically connected via the electric wire-attached terminal 25 and the bus bar 13.

### Configuration of first bolt 14

As shown in FIG. 3, the first bolt 14 that fastens and fixes the first connection portion 31 of the bus bar 13 includes a first head portion 41 and a shaft portion 42 that extends in the downward direction Z2 from the first head portion 41. The first bolt 14 of the present embodiment includes a bolt body 14A made of a metal, for example, and an insulating cap 14B made of a synthetic resin, for example. The insulating cap 14B is formed integrally with the bolt body 14A by, for example, insert molding. The bolt body 14A has a base portion 43 and the shaft portion 42. The shaft portion 42 extends in the downward direction Z2 from the base portion 43.

The first head portion 41 of the first bolt 14 of the present embodiment is constituted by the base portion 43 of the bolt body 14A and the insulating cap 14B that covers the upper surface of the base portion 43. The first head portion 41 includes a rotation receiving portion 44, to which a fastening tool (not shown) is attached and that receives rotational force from the tool, and a flange portion 45 that extends radially outward from the rotation receiving portion 44. The flange portion 45 extends entirely around the first head portion 41. The flange portion 45 has, for example, a circular shape when viewed from the direction along an axis L1 (Z axis direction). The flange portion 45 is formed by, for example, a portion of the base portion 43 of the bolt body 14A and a portion of the insulating cap 14B.

The first head portion 41 of the first bolt 14 has a first seating surface 46 and a second seating surface 47. The first seating surface 46 is provided on the lower surface (the end surface on the downward direction Z2 side) of the base portion 43 of the bolt body 14A. In the first head portion 41 of the first bolt 14, the first seating surface 46 is a flat surface that comes into contact with the first connection portion 31 in the axis L1 direction (Z axis direction) when the first bolt 14 is fastened. The second seating surface 47 is provided on the lower surface (the end surface on the downward direction Z2 side) of the flange portion 45. The outer diameter of the second seating surface 47 is larger than the outer diameter of the first seating surface 46. The second seating surface 47 is a surface that comes into contact with a portion of the inner housing 12 (a lower inward extending portion 63 described later) in the axis L1 direction (Z axis direction) when the first bolt 14 is fastened.

### Configuration of inner housing 12

The inner housings 12 are made of, for example, an insulating synthetic resin. The inner housings 12 are provided inside the housing body 21 for the purpose of preventing the touching of the bus bars 13 and the second bolts 15 when the lid 22 is removed. In other words, the inner housings 12 cover the bus bars 13 and the second bolts 15 in such a manner that, for example, a joint test finger of the protection class IPXXB does not come into contact with the bus bars 13 and the second bolts 15. Note that two inner housings 12 are provided in correspondence with the number of bus bars 13. The inner housings 12 are configured to be fastened and fixed together with the first connection portions 31 of the bus bars 13 by the first bolts 14.

Each of the inner housings 12 includes a first cover portion 51 that covers the first connection portion 31 of the bus bar 13, a second cover portion 52 that covers the second connection portion 32 of the bus bar 13, and a third cover portion 53 that covers the joining portion 33 of the bus bar 13.

### Configuration of first cover portion 51

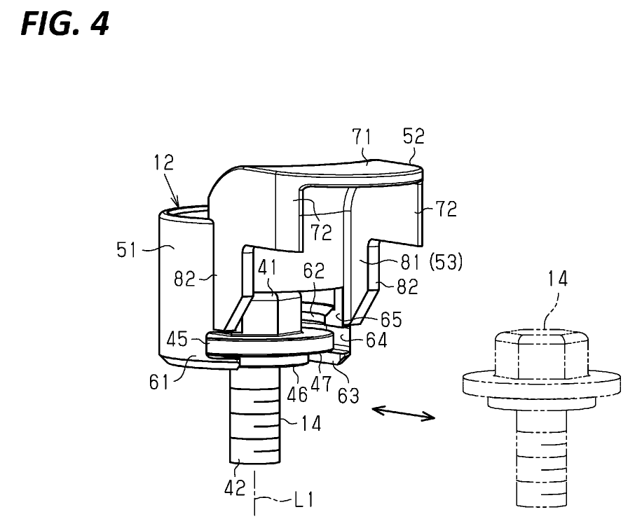

As shown in FIGS. 3 and 4, the first cover portion 51 of the inner housing 12 overall has a substantially cylindrical shape extending in the Z axis direction. The first cover portion 51 has a substantially cylindrical shape centered about the axis L1 of the first bolt 14. The first cover portion 51 is disposed on the upward direction Z1 side of the first connection portion 31 of the bus bar 13, and the first head portion 41 of the first bolt 14 is disposed inside the first cover portion 51.

The inner housing 12 include a bolt holding portion 61 at the lower end portion (the end portion on the downward direction Z2 side) of the first cover portion 51. The bolt holding portion 61 detachably holds the first head portion 41 of the first bolt 14 before fastening.

More specifically, the bolt holding portion 61 has an upper inward extending portion 62 and a lower inward extending portion 63 that extend from the inner peripheral surface of the first connection portion 31, and a mounting groove 64 formed between the upper inward extending portion 62 and the lower inward extending portion 63. The bolt holding portion 61 also has a cutout portion 65 (see FIG. 4) in a portion, with respect to the circumferential direction (a portion on the rearward direction X2 side), of the lower end of the substantially cylindrical first connection portion 31. This allows the flange portion 45 of the first bolt 14 to be passed through the cutout portion 65 in the direction orthogonal to the axis (the direction orthogonal to the axis L1) and slid into the mounting groove 64 of the bolt holding portion 61. When the flange portion 45 is fitted into the mounting groove 64, the flange portion 45 is held in the height direction (Z axis direction) by the upper inward extending portion 62 and the lower inward extending portion 63. Also, the first bolt 14 can be removed from the mounting groove 64 through the cutout portion 65.

### Configuration of second cover portion 52

The second cover portion 52 of the inner housing 12 extends in the rearward direction X2 from the upper end of the first cover portion 51. The second cover portion 52 includes an upper cover portion 71 and a pair of side cover portions 72.

The upper cover portion 71 is disposed on the upward direction Z1 side of the second connection portion 32 of the bus bar 13 and a second head portion 15a of the second bolt 15. In other words, the upper cover portion 71 covers the upward direction Z1 side of the second connection portion 32 and the second head portion 15a.

The pair of side cover portions 72 extend in the downward direction Z2 from the two widthwise edges of the upper cover portion 71. The pair of side cover portions 72 are disposed on respective widthwise sides of the second connection portion 32 of the bus bar 13 and the second head portion 15a of the second bolt 15. In other words, the pair of side cover portions 72 cover both sides of the second connection portion 32 and the second head portion 15a in the width direction.

### Configuration of third cover portion 53

The third cover portion 53 of the inner housings 12 includes a front cover portion 81 and a pair of side cover portions 82. The front cover portion 81 is disposed on the forward direction X1 side of the joining portion 33 of the bus bar 13, and faces the joining portion 33. In other words, the front cover portion 81 covers a portion of the joining portion 33 on the forward direction X1 side thereof.

The pair of side cover portions 82 extend in the rearward direction X2 from the two widthwise edges of the front cover portion 81. Furthermore, the pair of side cover portions 82 are, for example, integrally connected to the pair of side cover portions 72 of the second cover portion 52. The pair of side cover portions 82 are disposed on respective widthwise sides of the joining portion 33. In other words, the pair of side cover portions 82 cover portions of the joining portion 33 on both widthwise sides thereof.

### Operations of present embodiment

Operations of the present embodiment will be described below.

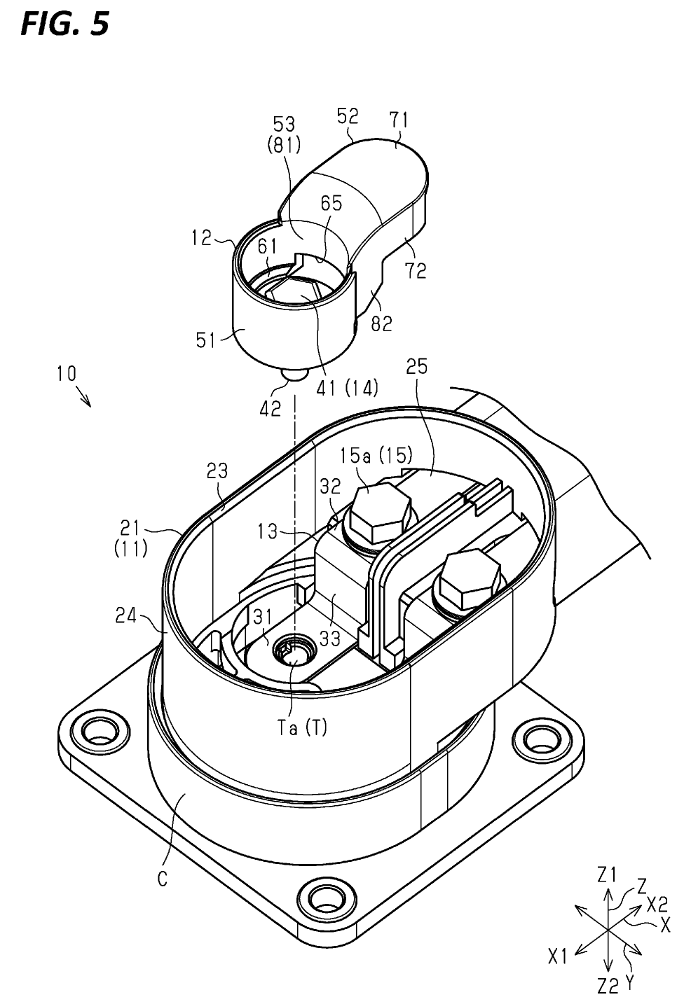

Before the connector 10 is mated with the partner connector C, the second connection portion 32 of each of the bus bars 13 is fastened and fixed to the corresponding wire-attached terminal 25 with use of the corresponding second bolt 15. The housing body 21 of the connector 10 is mated with the partner connector C, and the first connection portion 31 of the bus bar 13 is positioned on the upward direction Z1 side of the corresponding partner terminal T and then passed through the upper opening portion 23 of the housing body 21 and fastened and fixed with use of the corresponding first bolt 14 (see FIG. 5).

At this time, the first bolt 14 has been mounted to the bolt holding portion 61 of the inner housing 12 in advance so as to integrate the first bolt 14 and the inner housing 12 with each other. Then, the integrated assembly of the first bolt 14 and the inner housing 12 is positioned above the bus bar 13, and the shaft portion 42 of the first bolt 14 is screwed into a female threaded hole Ta of the partner terminal T, thereby fastening and fixing the first connection portion 31 of the bus bar 13 to the partner terminal T (see FIG. 3). At this time, the first seating surface 46 of the first head portion 41 of the first bolt 14 comes into contact with the upper surface of the first connection portion 31. As a result, axial force from the first bolt 14 acts directly on the first connection portion 31 of the bus bar 13.

Also, the second seating surface 47 provided on the lower surface of the flange portion 45 in the first head portion 41 comes into contact with the upper surface of the lower inward extending portion 63 of the inner housing 12, and the second seating surface 47 of the flange portion 45 and the upper surface of the first connection portion 31 sandwich the lower inward extending portion 63 in the Z axis direction (axis L1 direction). In this way, the lower inward extending portion 63 is sandwiched between the first connection portion 31 and the second seating surface 47, and the inner housing 12 is fastened and fixed by the first bolt 14. In other words, the lower inward extending portion 63 constitutes a fastened portion that is sandwiched and fixed between the first connection portion 31 and the second seating surface 47 in the inner housing 12. Also, in the inner housing 12, the pair of side cover portions 72 of the second cover portion 52 and the pair of side cover portions 82 of the third cover portion 53 interfere with the two widthwise edges of the bus bar 13 so as to restrict rotation of the inner housing 12 caused by co-rotation when the first bolt 14 is tightened.

As described above, due to attaching the first bolt 14 and the inner housing 12 that have been integrated with each other in advance, the inner housing 12 covers at least the upper side of the bus bar 13 while the first bolt 14 is placed and screwed in. Therefore, a fastening tool or the worker's finger is unlikely to touch the bus bar 13 when the first bolt 14 is placed and screwed in.

### Effects of present embodiment

Effects of the present embodiment will be described below.

(1) The inner housing 12 that covers the bus bar 13 is configured to be fastened and fixed together with the first connection portion 31 by the first bolt 14. According to this configuration, the bus bar 13 is covered by the inner housing 12 when the bus bar 13 and the partner terminal T are fastened together with a bolt. Therefore, the inner housing 12 can prevent the touching of the bus bar 13 when the bus bar 13 and the partner terminal T are fastened together with a bolt. Furthermore, with the configuration in which the inner housing 12 is fixed by the first bolt 14, it is not necessary to provide the inner housing 12 with a locking structure or the like for being fixed to the housing body 21 or the bus bar 13. This makes it possible to contribute to a reduction in the size of the inner housing 12 and, in turn, a reduction in the size of the outer housing 11.

(2) The inner housing 12 includes the bolt holding portion 61 configured to hold the first head portion 41 of the first bolt 14 before fastening. The first bolt 14 can be attached to and detached from the bolt holding portion 61 before fastening. According to this configuration, the first bolt 14 can be held by the bolt holding portion 61 of the inner housing 12 before fastening. This makes it possible for the inner housing 12 and the first bolt 14 held by the bolt holding portion 61 to be handled as a single assembly. As a result, it is possible to improve workability when fastening and fixing the bus bar 13 and the inner housing 12 to the partner terminal T.

(3) The first head portion 41 of the first bolt 14 has the first seating surface 46 configured to come into contact with the first connection portion 31, and the second seating surface 47 that has a larger diameter than the first seating surface 46 and is configured to come into contact with the lower inward extending portion 63 (fastened portion) that is a portion of the inner housing 12. The lower inward extending portion 63 is fixed by being sandwiched between the first connection portion 31 and the second seating surface 47. According to this configuration, the first head portion 41 of the first bolt 14 can be brought into direct contact with the bus bar 13 at the first seating surface 46, and the lower inward extending portion 63 of the inner housing 12 can be fixed by the second seating surface 47 of the first head portion 41 of the first bolt 14.

(4) The inner housing 12 includes the first cover portion 51 configured to cover the first connection portion 31, and the second cover portion 52 configured to cover the second connection portion 32. According to this configuration, the first connection portion 31 and the second connection portion 32 of the bus bar 13 can be covered by the first cover portion 51 and the second cover portion 52 of the inner housing 12, respectively. Therefore, the inner housing 12 can more effectively prevent the touching of the bus bar 13 when the bus bar 13 and the partner terminal T are fastened together with a bolt.

(5) The connector 10 includes the second bolt 15 configured to fasten and fix the second connection portion 32 and the wire-attached terminal 25 to each other. The second cover portion 52 covers the second connection portion 32 and the second head portion 15a of the second bolt 15. According to this configuration, the second cover portion 52 of the inner housing 12 can prevent the touching of the second bolt 15 that fastens the bus bar 13 and the wire-attached terminal 25 to each other.

(6) The bus bar 13 is shaped such that the first connection portion 31 is located on the downward direction Z2 side of the second connection portion 32. The inner housing 12 includes the third cover portion 53 configured to cover at least a portion of the joining portion 33 that connects the first connection portion 31 and the second connection portion 32 of the bus bar 13. According to this configuration, at least a portion of the joining portion 33 that connects the first connection portion 31 and the second connection portion 32 of the bus bar 13 can be covered by the third cover portion 53 of the inner housing 12. Therefore, the inner housing 12 can more effectively prevent the touching of the bus bar 13 when the bus bar 13 and the partner terminal T are fastened together with a bolt.

### Other embodiments

Modifications such as the following can be made to the above embodiment. The above-described embodiment and the following modified examples can be implemented in combination with each other as long as no technical contradiction arises.

In the above embodiment, the first bolt 14 may be configured without the insulating cap 14B. In this case, the entirety of the first head portion 41, including the rotation receiving portion 44 and the flange portion 45, may be formed by the base portion 43 of the bolt body 14A. In this case, in order to prevent the touching of the first head portion 41, it is desirable to design the diameter of the cylinder of the first cover portion 51 to be as small as possible while still allowing the first bolt 14 to be fastened.

In the above embodiment, the first seating surface 46 may be omitted from the first bolt 14.

In the above embodiment, the second connection portion 32 of the bus bar 13 is fastened and fixed to the wire-attached terminal 25 by the second bolt 15, but the present invention is not particularly limited to this. For example, the second connection portion 32 of the bus bar 13 may be connected to the wire-attached terminal 25 by welding or crimping, for example.

In the above embodiment, the bus bar 13 has a crank shape in which the first connection portion 31 is located on the downward direction Z2 side of the second connection portion 32, but the present invention is not particularly limited to this. For example, the first connection portion 31 may be located on the upward direction Z1 side of the second connection portion 32. Also, the bus bar 13 may entirely extend straight in the front-rear direction such that the first connection portion 31 and the second connection portion 32 are at the same position in the height direction (Z axis direction).

The configuration of the inner housing 12, such as the shape thereof, is not limited to that in the above embodiment, and can be modified as appropriate in accordance with the configuration of the connector 10. For example, the side cover portions 72 and 82 of the second cover portion 52 and the third cover portion 53 may be omitted from the inner housing 12.

In the inner housing 12 of the above embodiment, the lower inward extending portion 63 of the bolt holding portion 61 is fixed by the first bolt 14, but the present invention is not particularly limited to this.

In the inner housing 12 of the above embodiment, the bolt holding portion 61 is configured such that the first bolt 14 can be attached in a direction orthogonal to the axis, but alternatively, a configuration is possible in which the first bolt 14 can be attached along the axis L1 direction, for example.

The bolt holding portion 61 that holds the first head portion 41 of the first bolt 14 may be omitted from the inner housing 12. In this case, the inner housing 12 is positioned above the bus bar 13, and then the first bolt 14 is placed at a predetermined position, and the inner housing 12 and the first connection portion 31 of the bus bar 13 are fastened and fixed to each other by the first bolt 14.

The number of electric wires 26, wire-attached terminals 25, bus bars 13, inner housings 12, and partner terminals T is not limited to the numbers thereof in the above embodiment, and may be one, or three or more.

The materials forming the bus bar 13, the wire-attached terminal 25, and the core wire of the electric wire 26 are not limited to those in the above embodiment, and can be changed as appropriate in accordance with the configuration of the connector 10.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector comprising:
a bus bar having a first connection portion configured to be connected to a partner terminal, and a second connection portion configured to be connected to a wire- attached terminal;
an outer housing configured to house the bus bar;
a bolt configured to fasten and fix the first connection portion to the partner terminal; and
an inner housing configured to be housed in the outer housing and cover the bus bar,
wherein the inner housing is fastened and fixed together with the first connection portion by the bolt.

2. The connector according to claim 1,
wherein the inner housing includes a bolt holding portion configured to hold a head portion of the bolt in an unfastened state, and
the bolt holding portion is attachable to and detachable from the bolt in the unfastened state.

3. The connector according to claim 1,
wherein the head portion of the bolt has a first seating surface configured to come into contact with the first connection portion, and a second seating surface having a larger diameter than the first seating surface and configured to come into contact with a fastened portion that is a portion of the inner housing, and
the fastened portion is fixed by being sandwiched by the first connection portion and the second seating surface.

4. The connector according to claim 1,
wherein the inner housing includes a first cover portion configured to cover the first connection portion, and a second cover portion configured to cover the second connection portion.

5. The connector according to claim 4,
wherein letting the bolt be a first bolt, the connector further comprises a second bolt configured to fasten and fix the second connection portion and the wire- attached terminal to each other, and
the second cover portion covers the second connection portion and a head portion of the second bolt.

6. The connector according to claim 4,
wherein the bus bar is shaped such that the first connection portion is lower than the second connection portion, and
the inner housing includes a third cover portion configured to cover a joining portion that connects the first connection portion and the second connection portion of the bus bar.
